(19) United States
(12) Patent Application Publication
(10) Pub. No.: US 2003/0212583 A1
(43) Pub. Date: Nov. 13, 2003

(54) Automated tool set for improving operations in an ecommerce business

(76) Inventors: Francis A. Perras JR., Wayne, PA (US); Christine A. Eberle, Reston, VA (US); Andrew Hamilton, Washington, DC (US)

Correspondence Address: ACCENTURE C/O MORRISON & FOERSTER, 755 PAGE MILL ROAD, PALO ALTO, CA, 94304, US

(21) Appl. No.: 09/916,132

(22) Filed: Jul. 25, 2001

(51) Int. Cl. G06F 17/60

(52) U.S. Cl. 705/7

(57) ABSTRACT

The present invention provides a system of automated data driven tools which are integrated to provide an orderly and efficient set of concrete, specific and useful plans to help companies attain organizational and operational excellence. A system is disclosed which includes a set of ePerformance metric development tools, a set of BestPeople tools for force planning and analysis, with a companion set of eLearning tools to provide strategic employee development assistance and a set of eJourney management tools to assist in self measurement, metric comparisons, and plans development. An exemplary preferred embodiment is described which teaches a new and unique workforce transformation system to illustrate a concrete specific implementation result.

### COPYRIGHT NOTICE

A portion of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to the field of data processing systems, and more particularly, the present invention relates to a method and system for using a set of automated tools to improve the operation of an eCommerce company so as to produce concrete, tangible and useful solutions to operational problems in an eCommerce company.

### BACKGROUND ART

A technical problem presently exists in the area of finding optimal solutions to eCommerce business organizational and strategic problems. The development of such optimal solutions typically involves a two step process. First, significant amounts of data must be processed and analyzed in order to identify candidate solution sets for these business problems; and second, creative, business based evaluation of these solution sets must be performed to develop a solution set which is most appropriate for a particular business entity. The prior art contains a plethora of business metrics with which a business entity can compare its operational performance to its competitors. Metrics such as “Return on Investment (ROI)”, or “Return on Equity (ROE)”, “Revenue per Employee”, “Contribution per Employee”, “Sales per Marketing Employee”, “Profit per employee”, etc., etc. Similarly the prior art is replete with business planning guides such as “How to do a 5 year plan”, “How to determine your core competencies”, “How to evaluate your personnel”, etc., etc. And similarly, there are a multitude of documents and systems aimed at developing customer statistics and demographic data for almost every kind of business, and especially via the Internet through web-page related measurement devices such as cookies, and web bugs. The technical problem lies in the fact that there are no known systems to coordinate the capture of all of the required data to make use of these techniques, warehouse the data, and assist in the automated generation of specific, concrete and useful business management plans which can be monitored with acceptable metrics on an ongoing basis. This appears to be true especially for businesses attempting to develop an eCommerce presence in the Internet based marketplace. Thus the need for effective web-based data-driven management tools is evident.

The present pace of automation and Internet-based business development in the global marketplace has prompted the appearance of a number of automation/software service companies who offer services which help companies increase profits and efficiency by implementing software based on complexity science, a broad field that includes chaos theory. Complexity researchers use genetic algorithms, artificial neural networks, and other tools to create models of real world systems ranging from steel production to the immune system. Companies such as Bios Group™, i2 Technologies™, Prediction™, and Artificial Life™ are developing complexity applications for the business world. These are applications which simulate an existing company's operations, such as airline cargo operations, customer order handling operations and various pricing strategies. These simulations typically make use of genetic algorithms, simulation of biological processes by using neural patterning, and by using software agents and electronic robots (“bots”) and computer models to conduct various studies. Such systems typically involve hundreds if not thousands of constraints in the model and involve many complex calculations. These new applications are described in general in the article titled “Complexity's Business Model” in Scientific American (01/01) Vol. 284, No. 1, P. 31; by Julie Wakefield, which is hereby incorporated fully herein by reference. This article can be referenced on-line at the URL=www.sciam.com/2001/0101issue/0101techbus1.html.

These new simulation techniques, like the various management mechanisms described earlier for business metric development, sales demographics capture and strategic planning using these data, do not solve the technical problem of integration of automated tools to capture and efficiently use data for all of these purposes.

Other attempts to provide such data gathering and analysis in specific categories are provided by AnswerThink.com™ (benchmarking and customer research services); MetaPraxis.com™ (performance visualization software); emetrics.com™ (tools to measure e-business opportunity); Globalbenchmarking.com™ (benchmarking community, best practices database); Best Practices LLC™ (benchmarking reports, best practice database); CyberDialogue.com™ (web practices analysis, proprietary econsumer database); ComputerPsychologist.com™ (on-line psychological testing and employment screening); BenchmarkingNetwork.com™ (consultants with best practices experience, proprietary database of key performance indicators); ServiceMetrics.com™ (software to measure e-commerce performance including web/Internet performance); The Foundation For Performance Measurement™ (data-driven management consultants); Applied Measurement Professionals, Inc.™ (occupational certification services for organizations such as Associations, etc.); LxrTest.com™ (software for educational testing); and IndustryMetrics.com™ (surveys & polls, low-cost on-line benchmarking).

Never-the-less there continues to be a need for a solution to the technical problem of providing a coordinated, integrated set of analysis and management tools based around a central set of databases which can provide the data-driven results for a given eCommerce business. What is needed for a business user is a “one-stop-shopping” like web-based program management system, encompassing all information pertaining to a specific project, which contains the critical few metrics that corporations must track to manage workforce transformation initiatives. An exemplary preferred embodiment is described which teaches a new and unique workforce transformation management system to illustrate a concrete specific result.

### SUMMARY OF THE INVENTION

The present invention provides a solution to the needs described above through a system of automated data driven tools which are integrated to provide an orderly and efficient set of concrete, specific and useful plans to help companies attain organizational and operational excellence. A system is disclosed which includes a set of ePerformance metric development tools, a set of BestPeople tools for force planning and analysis, with a companion set of eLearning tools to provide strategic employee development assistance and a set of eJourney management tools to assist in self measurement, metric comparisons, and plans development. An exemplary preferred embodiment is described which teaches a new and unique workforce transformation management system to illustrate a concrete specific implementation result

A method is disclosed for providing a specific, concrete and useful solution to the technical problem of providing an integrated, coordinated set of tools and processes to make use of a set of ePerformance metric development tools, a set of BestPeople tools for force planning and analysis, with a companion set of eLearning tools to provide strategic employee development assistance and a set of eJourney management tools to assist in self measurement, metric comparisons, and plans development.

Still other embodiments of the present invention will become apparent to those skilled in the art from the following detailed description, wherein is shown and described only the embodiments of the invention by way of illustration of the best modes contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive.

### DESCRIPTION OF THE DRAWINGS

The features and advantages of the system and method of the present invention will be apparent from the following description in which:

FIG. 1 illustrates a typical configuration of Internet connected systems representative of the preferred embodiment of the present invention.

FIG. 2 illustrates a typical general purpose computer system of the type representative of the preferred embodiment.

FIG. 3 illustrates the general three tier relationship between user, web-servers and their related applications-server, and the database management system.

FIG. 4 illustrates a more detailed depiction of the applications-server portion of such a system as shown in FIG. 3 illustrating the business applications of the present invention.

FIG. 5 depicts a flow chart of a typical process of interaction between a client and the eBusiness tools to develop a strategic assessment plan.

FIG. 6 depicts a lifecycle of a start-up company indicating where the present invention would be used to enhance the development of the company.

FIG. 7 is a screen shot of an exemplary user interface screen for an exemplary workforce deployment management system.

FIG. 8 is an expanded partial view of the selection menu (“main menu”) for various online work centers as indicated in FIG. 7.

FIG. 9 is a screen shot of the user interface screen of FIG. 7 after selecting the “executive scorecard” pointer from the main menu.

FIG. 10 is an expanded view of the “executive scorecard” menu shown on FIG. 9.

FIG. 11 is a partial screen shot of the exemplary financial metrics shown when the “Program Management/Financial” pointer on the “executive scorecard” menu is selected.

FIG. 12 is a partial screen shot of the exemplary Executive Scorecard data shown when the “Capability Development” pointer on the “executive scorecard” menu is selected.

FIG. 13 is a partial screen shot of the exemplary Executive Scorecard data shown when the “Capability Deployment” pointer on the “executive scorecard” menu is selected.

FIG. 14 is a partial screen shot of the exemplary Executive Scorecard data shown when the “Business Impact” pointer on the “executive scorecard” menu is selected.

FIG. 15 is an exemplary screen shot which appears when the “Mine for Data” pointer on the Main Menu is selected.

FIG. 16 is a partial screen shot of the Mine for Data screen shown when one of the Business Units is selected.

FIG. 17 is an exemplary screen shot which appears when the “Customer Satisfaction” pointer on the screen shown in FIG. 16 is selected.

FIG. 18 is a partial screen shot of exemplary Call Center Metrics which would appear for a selected business unit after a time range and area are selected.

FIG. 19 is a partial screen shot of exemplary Customer Satisfaction Metrics which would appear for a selected business unit after a time range and area are selected.

FIG. 20 is a partial screen shot which appears when the “Sales” pointer on the screen shown in FIG. 16 is selected.

FIG. 21 is a partial screen shot of exemplary Sales Metrics which would appear for a selected business unit after a time range and area are selected.

FIG. 22 is a partial screen shot of exemplary choices available when the “Calendar” pointer in the “Planning” section of the Main Menu is selected.

FIG. 23 is a partial screen shot showing a typical calendar example for the Team selected in the screen shown in FIG. 22.

FIG. 24 is an exemplary screen shot showing an exemplary link to a workplans tool which would appear when the “workplans” pointer under the Planning section of the main menu is selected.

FIG. 25 is an exemplary screen shot showing an exemplary menu of choices available when the “Issues log” pointer under the Planning section of the main menu is selected.

FIG. 26 is a partial screen shot showing exemplary issue entry data boxes available when the “Enter a new Issue” pointer is selected.

FIG. 27 is a partial screen shot showing exemplary existing issue data available when the “View existing Issues” pointer is selected.

FIG. 28 is an exemplary screen shot which appears when the “Close an Issue” pointer is selected.

FIG. 29 is an exemplary screen shot which appears when the “Accomplishments” pointer under the Contributions section of the Main Menu is selected.

FIG. 30 is a partial screen shot showing exemplary data entry boxes available when the “Submit Accomplishments” pointer is selected.

FIG. 31 is a partial screen shot showing exemplary data available when the “View Accomplishments” pointer is selected.

FIG. 32 is a partial screen shot showing exemplary data entry boxes available when the “Feedback” pointer under the Contributions section of the Main Menu is selected.

FIG. 33 is a partial screen shot showing exemplary data entry boxes available when the “Discussion Forum” pointer under the Contributions section of the Main Menu is selected.

FIG. 34 is a partial screen shot showing exemplary data entry links available when the “Learn-a-Little” pointer icon (see 715 in FIG. 7) on the exemplary home page is selected.

FIG. 35 is a partial screen shot showing exemplary data entry links available when the “Live-a-Little” pointer icon (see 717 in FIG. 7) on the exemplary home page is selected.

### DETAILED DESCRIPTION OF THE INVENTION

The present invention provides a solution to the needs described above through a system of automated data driven tools which are integrated to provide an orderly and efficient set of concrete, specific and useful plans to help companies attain organizational and operational excellence. An automated eBusiness tools system is disclosed which includes a set of ePerformance metric development tools, a set of BestPeople tools for force planning and analysis, with a companion set of eLearning tools to provide strategic employee development assistance and a set of eJourney management tools to assist in self measurement, metric comparisons, and plans development. An exemplary preferred embodiment is described which teaches a new and unique workforce transformation system to illustrate a concrete specific implementation result

### Operating Environment

The environment in which the present invention encompasses the use of general purpose computers as client or input machines for use by business users of various kinds, including clerks, managers, teachers, engineers, project team members, and/or systems administrators. Such client or input machines may be coupled to the Internet (sometimes referred to as the “Web”) through telecommunications channels which may include wireless devices and systems as well.

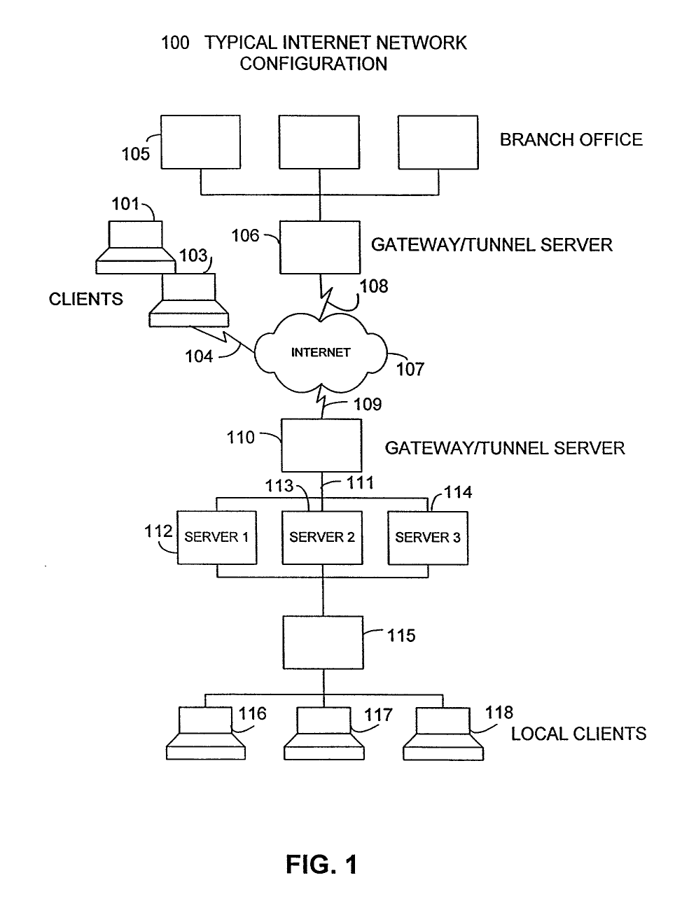

Some of the elements of a typical Internet network configuration are shown in FIG. 1, wherein a number of client machines 105 possibly in a branch office of a large enterprise, a manufacturer, a financial enterprise, etc., are shown connected to a Gateway/hub/tunnel-server/etc. 106 which is itself connected to the internet 107 via some internet service provider (ISP) connection 108. Also shown are other possible clients 101, 103 possibly used by other application systems users, or interested parties, similarly connected to the internet 107 via an ISP connection 104, with these units communicating to possibly a home office via an ISP connection 109 to a gateway/tunnel-server 110 which is connected 111 to various enterprise application servers 112, 113, 114 which could be connected through another hub/router 115 to various local clients 116, 117, 118. Any of these servers 112, 113, 114 could function as a server of the present invention, as more fully described below. Any user situated at any of these client machines would normally have to be an authorized user of the system as described more fully below.

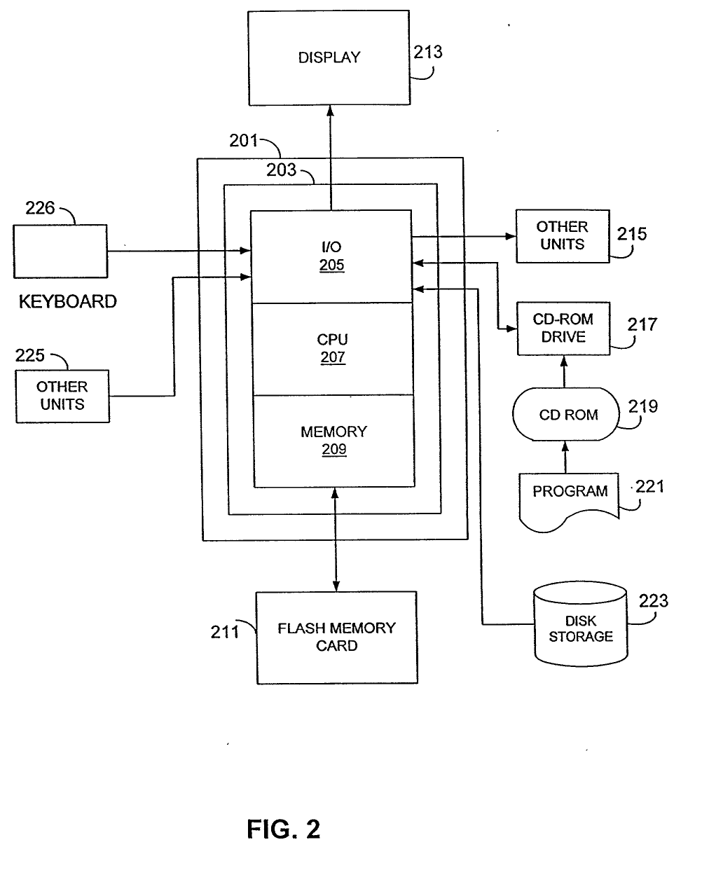

An embodiment of the automated eBusiness tools system of the present invention can operate on a general purpose computer unit which typically includes generally the elements shown in FIG. 2. The general purpose system 201 includes a motherboard 203 having thereon an input/output (“I/O”) section 205, one or more central processing units (“CPU”) 207, and a memory section 209 which may or may not have a flash memory card 211 related to it. The I/O section 205 is connected to a keyboard 226, other similar general purpose computer units 225, 215, a disk storage unit 223 and a CD-ROM drive unit 217. The CD-ROM drive unit 217 can read a CD-ROM medium 219 which typically contains programs 221 and other data. Such programmed computers may also be connected electronically to database systems such as those available from Oracle™, Sybase , Informix™, SQLServer from Microsoft™ and the like. Logic circuits or other components of these programmed computers will perform series of specifically identified operations dictated by computer programs as described more fully below.

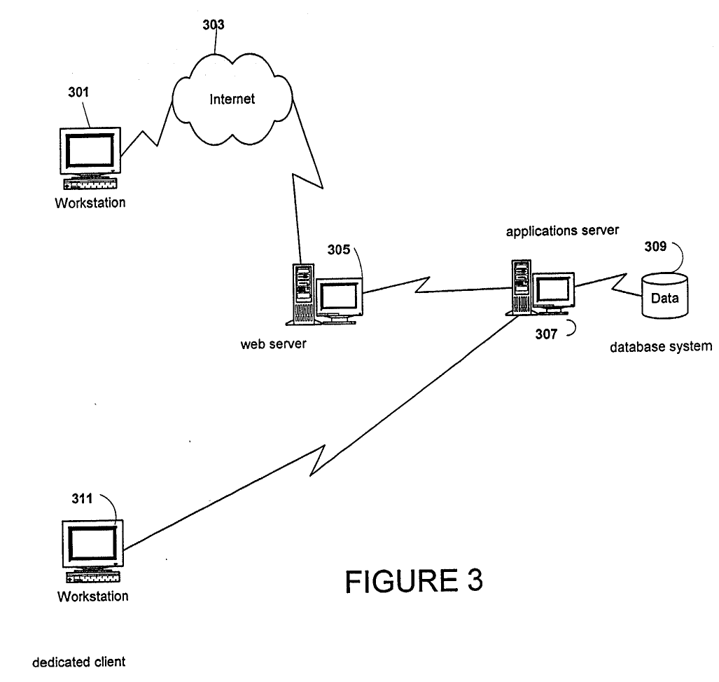

In an alternative embodiment, the environment of the present invention may be as shown in FIG. 3. In FIG. 3, a basic three tier web oriented system is depicted showing a tier 1 client workstation 301 electronically coupled to the Internet 303, and therefrom to a tier 2 web server 305, which itself is coupled to a tier 3 applications server 307. The applications server 307 would contain the software tools of the present invention, along with mechanisms to store and retrieve data and business rules from a database system 309. The applications server 307 would also contain mechanisms to communicate directly with dedicated clients 311 to provide access to the software tools of the present invention, and thereby to enhance data collection and reporting.

General System Description

The automated eBusiness tools system of the present invention is now described in general overall terms followed by descriptions of the discrete component tool sets in more detail. In general a preferred embodiment with a presently known best mode for making and using the system is described. Alternative embodiments are similarly described for various parts of the system.

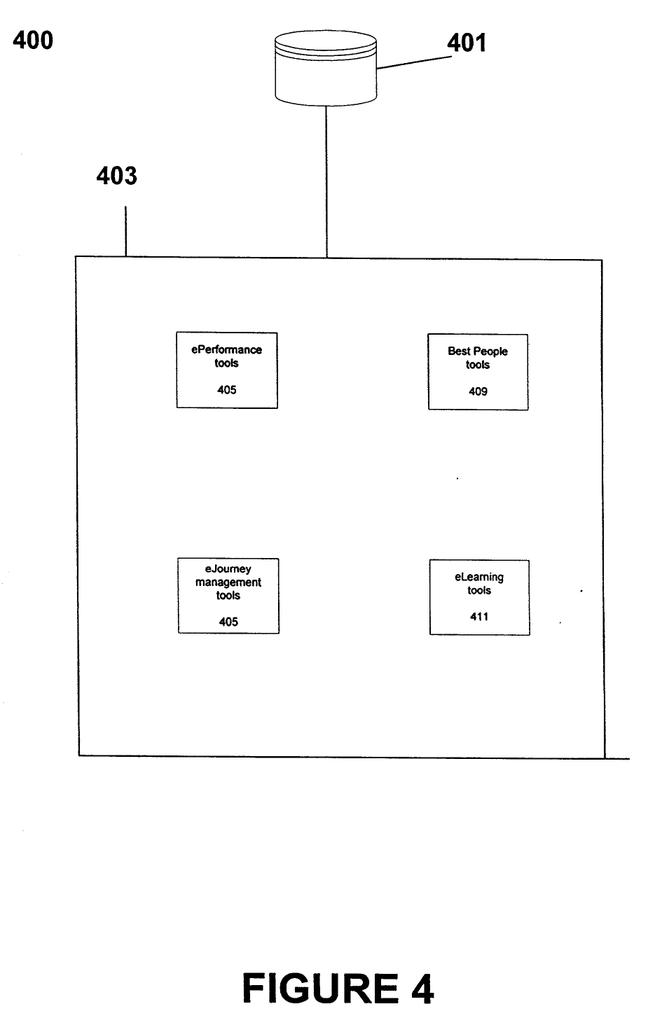

Referring now to FIG. 4, The automated eBusiness tools system of the present invention generally combines data mining tools, relational databases, dynamic report generators for various industry comparisons and for use in data analysis, on-line event monitor and reporting systems, and various tools for use by business experts in business data analysis and business simulation data control and analysis. All of these tools could be contained in a single applications server platform 403, or some of the tool sets could be physically located on a separate server, electronically coupled whenever required. In such a configuration the applications server platform 403 would be electronically coupled to a database system 401. Component tool sets include ePerformance Metric development tools 405, BestPeople Performance Analysis tools 409, eLearning tools 411 and a set of eJourney Management tools 408.

The automated eBusiness tools system of the present invention is generally used by existing companies which have decided to modernize a part of their business by development of new departments or functions which are to be organized to use and provide automation based services, generally involving the Internet and/or wireless technology based systems and services. Such new departments or functions are typically completely new organizations which are developed to replace antiquated service or sales organizations.

Alternatively, Workforce transformation occurs when employees are “retooled” to become more efficient, more effective, and to better meet the needs of customers. There are many applications of workforce transformation including (but not limited to) system deployment initiatives; web-based training; performance simulation; employee retention initiatives; and employee efficiency initiatives.

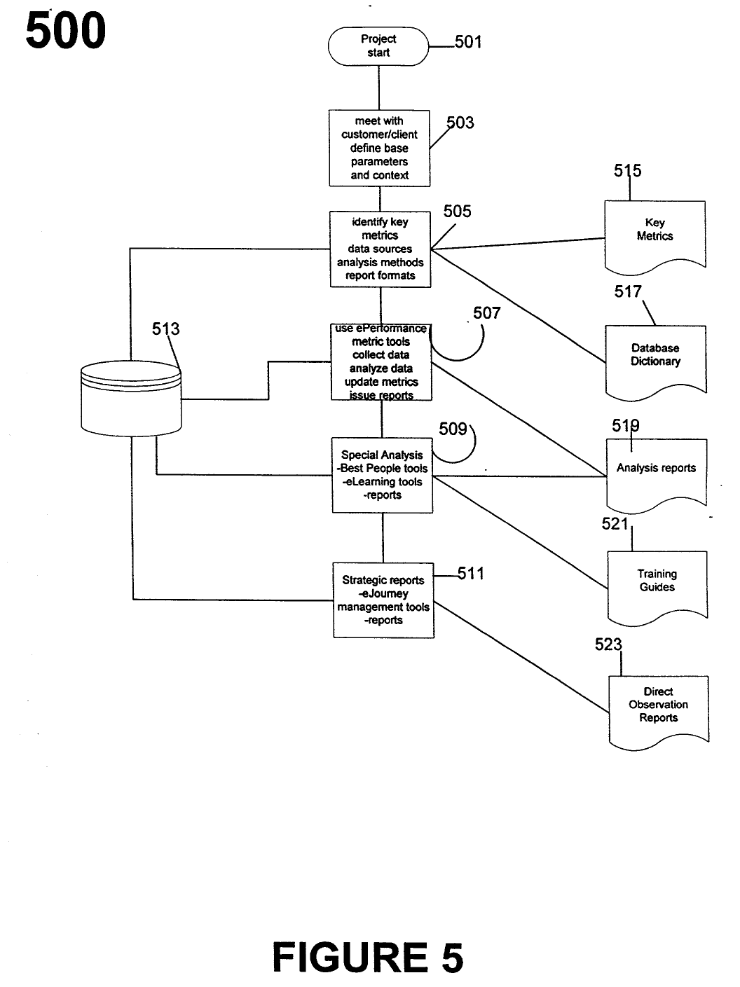

A typical use of the tools of the present system would include the following general steps shown in FIG. 5. Referring now to FIG. 5, the present invention could be used as follows for an exemplary project. Upon initiation of the project 501, a meeting with the customer/client is held 503 to define the context and base parameters (such as project managers, customer group/type, product/service to be evaluated, etc.). Next for the specified context and product/service to be evaluated, metrics to be used are identified as well as data sources for each metric 505. Also acceptable analysis methods are established and report formats specified. This identification activity 505 results in a base report of key metrics 515 which is subsequently updated periodically as the project develops, by making use of (mining) the datastore of similar metric and source data 513. Additionally a database directory 517 is produced to guide the users and analysts in manipulating the data store for the project. As more data is collected and becomes available in the datastore 513 the ePerformance tool set of the present invention is used to record the new data, analyze the collected data, update metric values 507 and issue periodic reports 519. In our example, the ePerformance tools may indicate a lack of personnel resources availability via the analysis reports 519 which could trigger a core competency analysis using the Best People tools 509 which could analyze the employee data contained in the datastore 513 and produce additional analysis reports 519. The Best people tools could automatically invoke the eLearning tools 509 which would produce suggested training guides 521 for existing employees who are trainable but lacking certain critical skills, by also accessing the training requirements, core competencies needed and available employee skills from the associated database 513. Finally, the system of the present invention could automatically invoke the eJourney management tools set to produce reports 523 along with direct observation reports, which reports describe recommended steps, given the existing constraints of material resources and people skills, to maximize the companies performance relative to the specified key metrics.

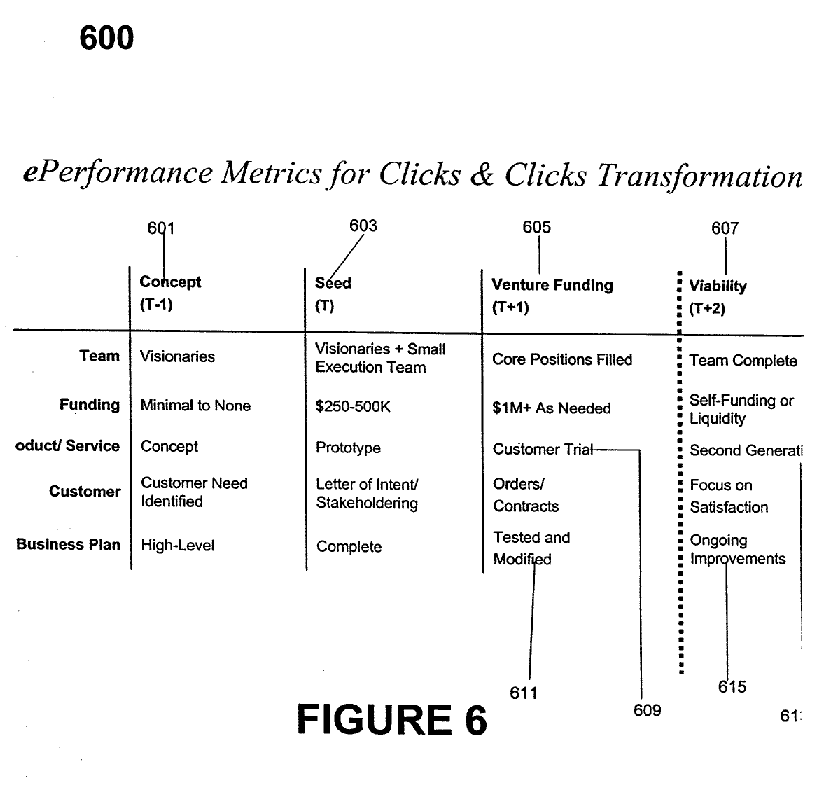

Such new developments are not unlike start-up companies which are formed to provide new Internet-based sales or services, and thus such start-up companies are also typical users of the present invention. For example, referring now to FIG. 6, a typical life cycle of a start-up eCommerce company is depicted. The start-up company begins in the “concept” stage 601 and having developed the concepts, identified a customer need and completed a general business plan, the company advances to the “seed” stage 603 wherein product prototypes are usually built and the business plan completed for the 3-5 year initial horizon. If they are well received, venture funding will be provided at the next stage 605. It is at this stage that the business plan is tested and modified 611 as the result of customer trials 609. It is in these two critical areas (the monitoring, measuring with key business metrics and analysis of the customer trials 609, and in the analysis of the business plan 611) that the applicants' invention becomes of most important use to the start-up company. As indicated in the example above, applicants invention would be used at these points to assist in developing the datastore, collecting the data, defining the relevant business metrics, monitoring the customer trials (including the related people actions, skills and expected versus actual performances) and business results compared to the specified metrics.

As the start-up eCommerce company crosses over to the “Viable” stage 607 applicants' invention would come into play again in evaluating and monitoring second generation and follow-on product/service offerings 613. Additional strategic business decisions are aided by applicants' invention through monitoring the business results relative to the business plan and specified metrics 615.

Those skilled in these arts will understand that various other business contexts and scenarios such as web-based training initiatives, system deployment initiatives, employee efficiency initiatives, etc., can make use of applicants' invention to produce similar actions which will fall within the scope of the claims for this invention as articulated below.

Detailed System Description

An exemplary detailed description of the present invention as used in a workforce transformation setting are now described in more detail. As indicated above, Workforce transformation occurs when employees are “retooled” to become more efficient, more effective, and to better meet the needs of customers. There are many applications of workforce transformation including (but not limited to) system deployment initiatives; web-based training; performance simulation; employee retention initiatives; and employee efficiency initiatives.

This exemplary system combines traditional web-based program management tools (e.g., an “Intranet” or “Portal”) with a dynamic, queriable database and executive scorecard. As such, it is a secure tool designed to track and manage large-scale workforce transformation initiatives.

In a preferred embodiment there are five main online Centers that comprise this example. These include: Knowledge

Planning

Contribution

Information

Balanced Lifestyle

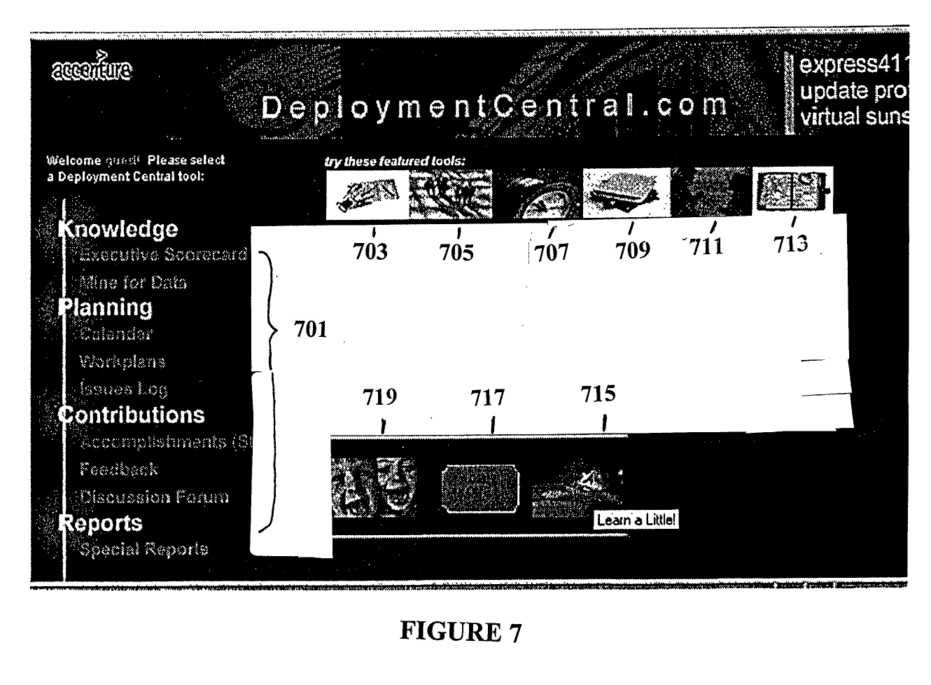

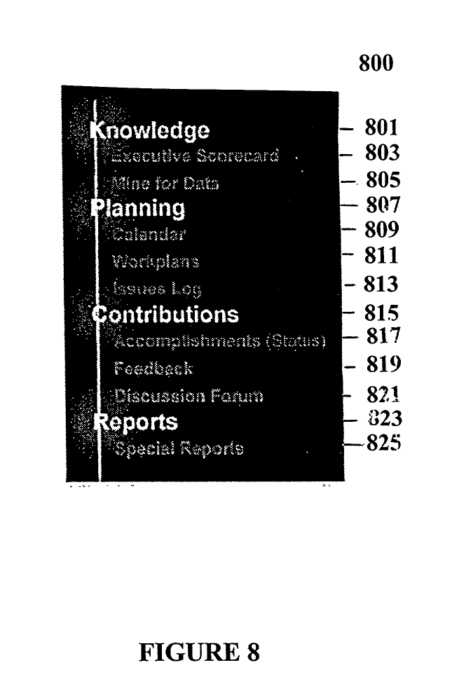

These online centers comprise a “Main Menu” shown on an exemplary user display (FIG. 7). Pointers to lower level screens in each category, representative of system tools in each category, are shown in FIG. 8.

Each Center will be described in greater detail below.

1. The Knowledge Center

The main purpose of The Knowledge Center is to provide access to data. End-users may view, manipulate, graph, and download data.

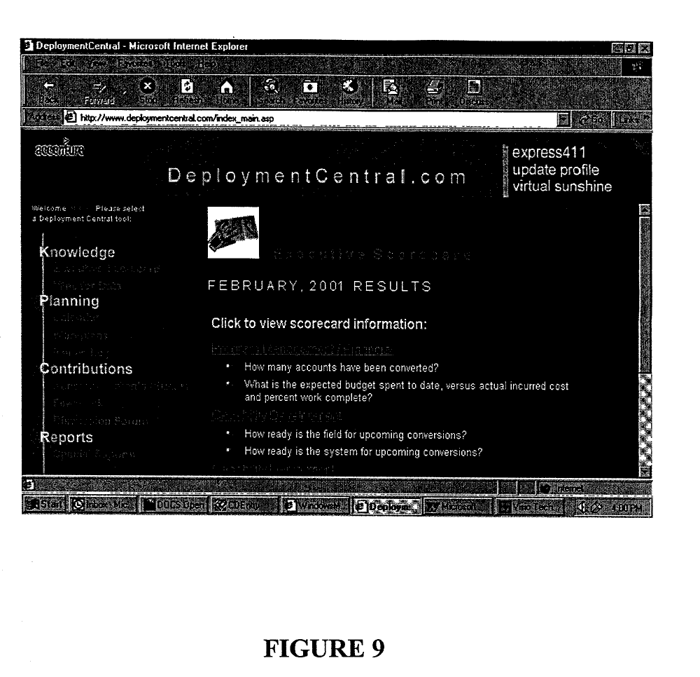

For a high-level project status, users can access the Executive Scorecard (FIGS. 9 & 10). This feature is unlike other published scorecards in that it captures metrics pertaining to a particular workforce transformation initiative, as opposed to enterprise-wide operations. The Executive Scorecard can be updated quarterly, monthly, weekly, or even daily—depending on user needs.

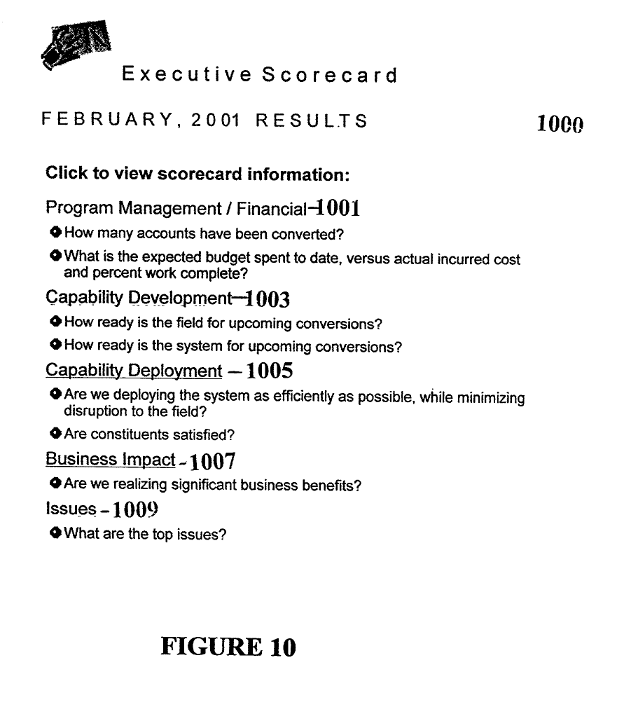

Referring now to FIG. 10, the exemplary Executive Scorecard is divided into five main sections, whose titles function as links (pointers) to lower level data in each category. These include: Program Management/Financial 1001; Capability Development 1003; Capability Implementation or Deployment 1005; Business Benefits 1007; and Issues 1009. Those skilled in these arts will recognize that other categories of executive metric tools may be added to such a system.

There are several high-level metrics in the exemplary Program Management/Financial category that are germane to all workforce transformation initiatives. These include:

Percent work complete (e.g., to date, what percentage of employees have been through workforce transformation program)

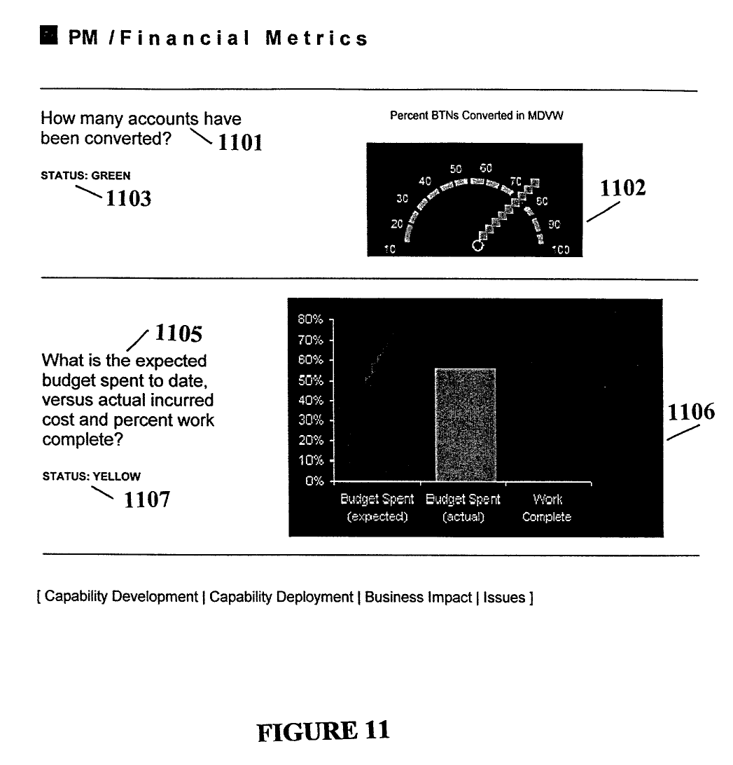

Work complete target (e.g., according to plan of record, how many employees currently should have completed workforce transformation program) (FIG. 11, 1102)

Percent budget spent (e.g., to date, what percentage of total project budget has been spent) (1111 )

Budget spent target (e.g., according to plan of record, what percentage of budget should have been spent) (1109).

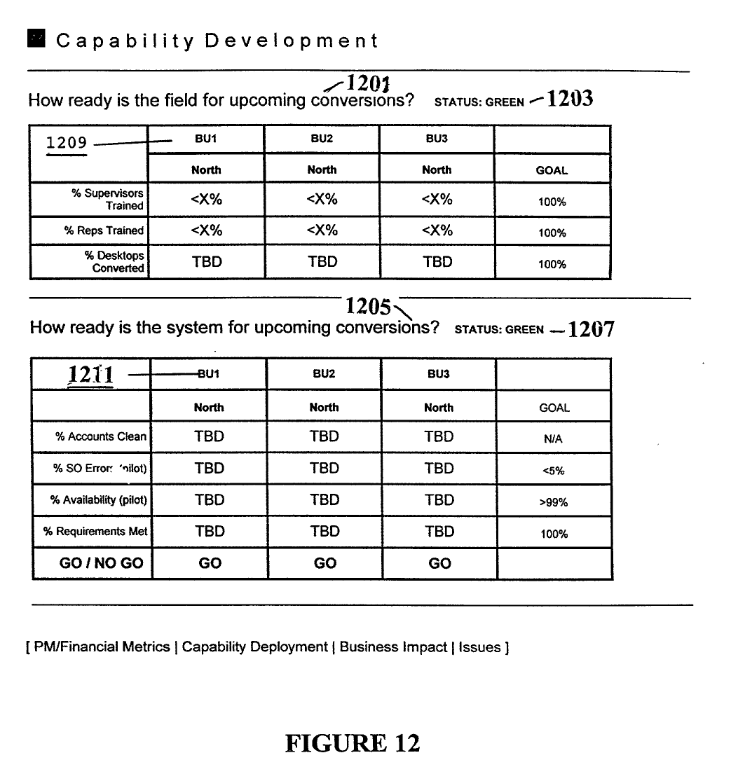

The exemplary Capability Development category captures project implementation readiness. Metrics will vary depending on the nature of the workforce transformation initiative. For example, a systems transformation initiative might include metrics pertaining to both system and field readiness, and for a number of business units and locations. (see FIG. 12).

System readiness 1205 metrics examples include the number of system troubles encountered during a pilot; whether required functionality has been delivered; and rounds of Client Acceptance Testing (CAT) completed.

Field readiness 1201 metrics examples include number of employees trained on new system; pre-deployment employee proficiency testing; on-site support readiness.

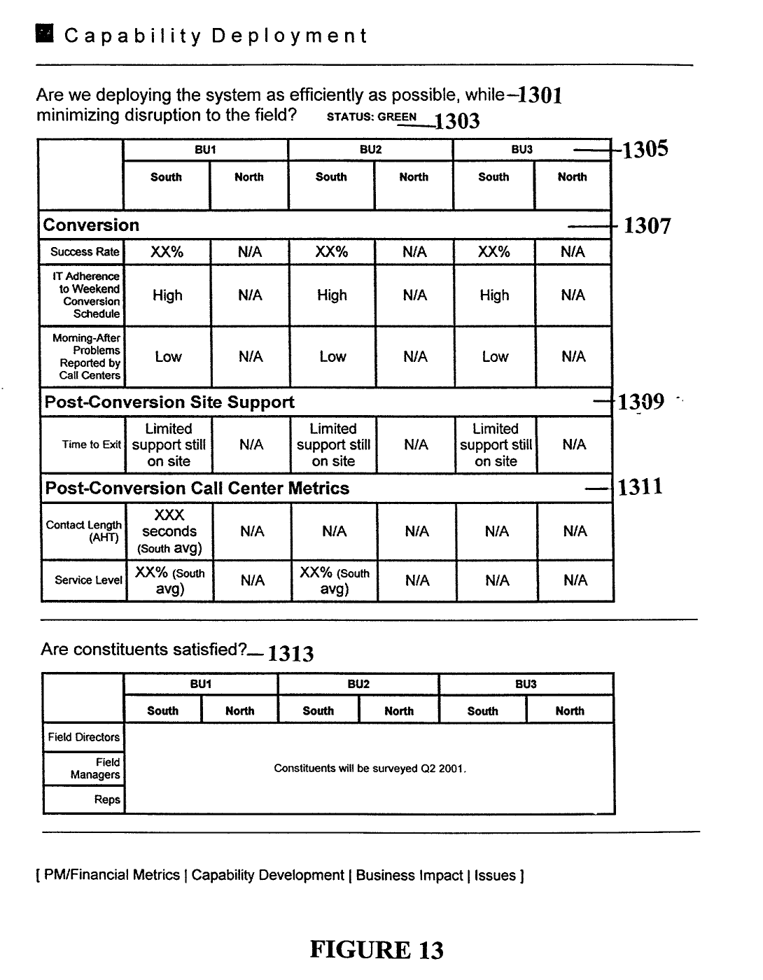

The Capability Implementation or Deployment category (FIG. 13) involves metrics about how well a workforce transformation initiative is being carried-out. Examples include:

Constituent satisfaction

Service level agreements

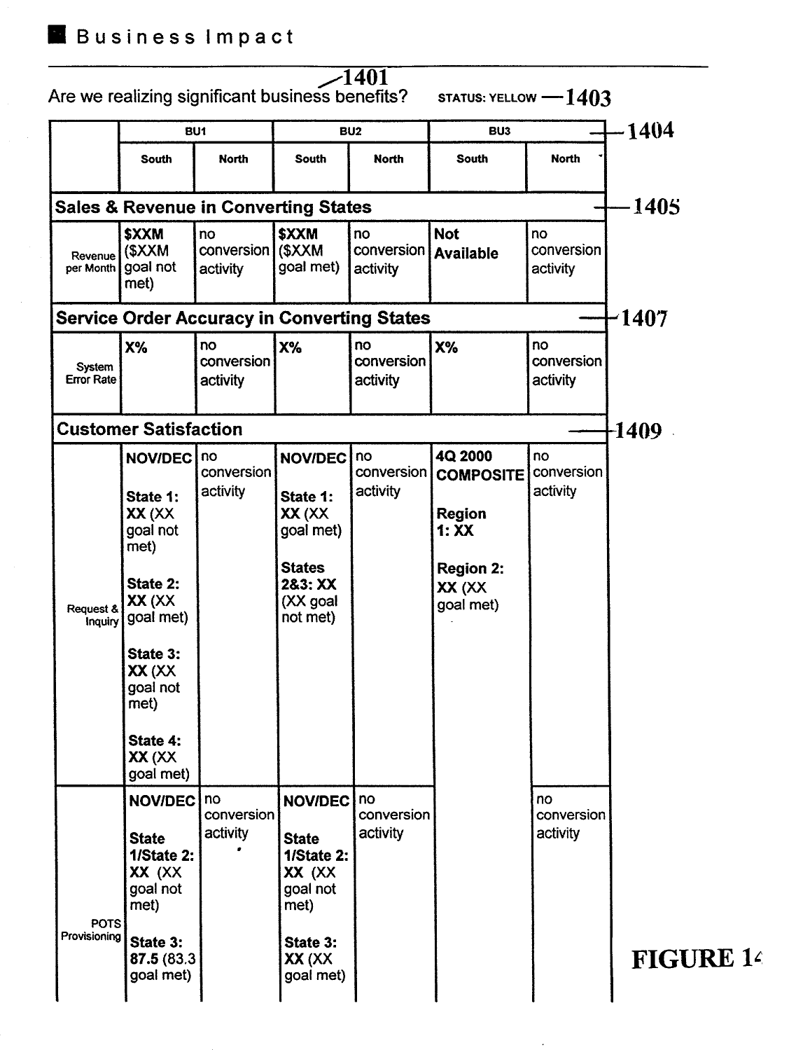

The Business Benefits category (FIG. 14) reflects the extent to which expected improvements are being realized. Metrics will vary depending on the nature of the workforce transformation initiative. Examples include:

Customer satisfaction

Employee efficiencies

Operational efficiencies/decreased cost

Enhanced revenue

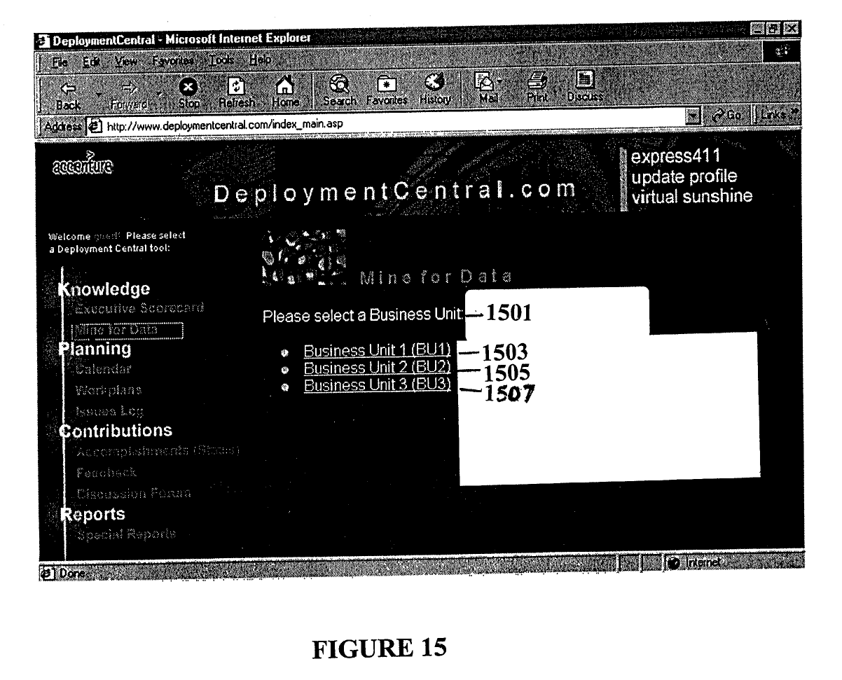

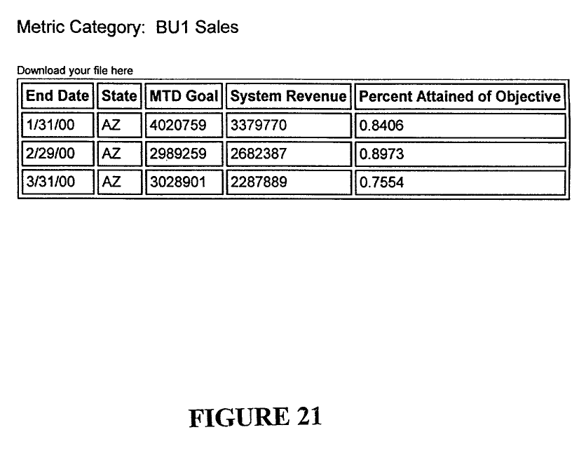

The Knowledge Center also includes a tool called Mine For Data that enables users to access and manipulate low-level historical data (FIGS. 15-21). For example, if the Executive Scorecard provides current information about project implementation across multiple regions, Mine for Data (the pointer to this tool is at 805, FIG. 8) enables users to select jurisdictional data for specific dates or date ranges. Functionality includes:

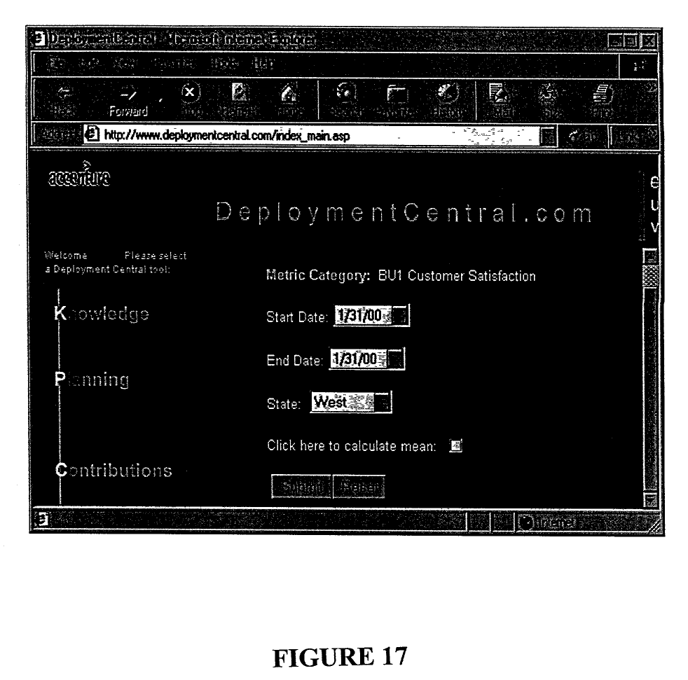

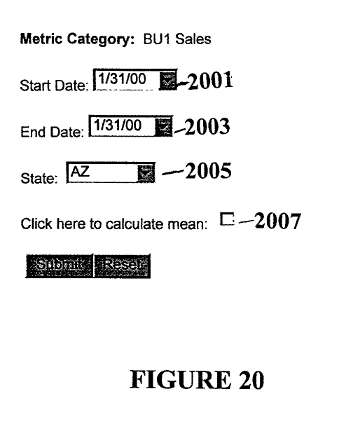

Search by date (FIGS. 17, 20)

Search by region (FIGS. 17, 20)

Search by business unit (FIG. 15)

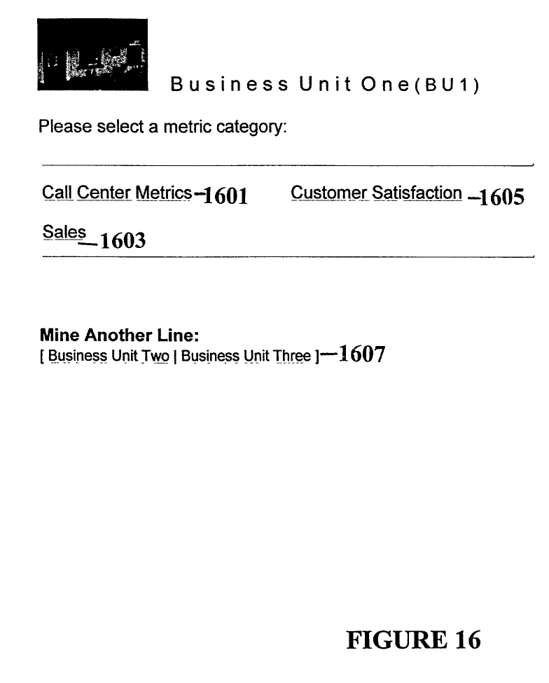

Search by metrics category (FIG. 16)

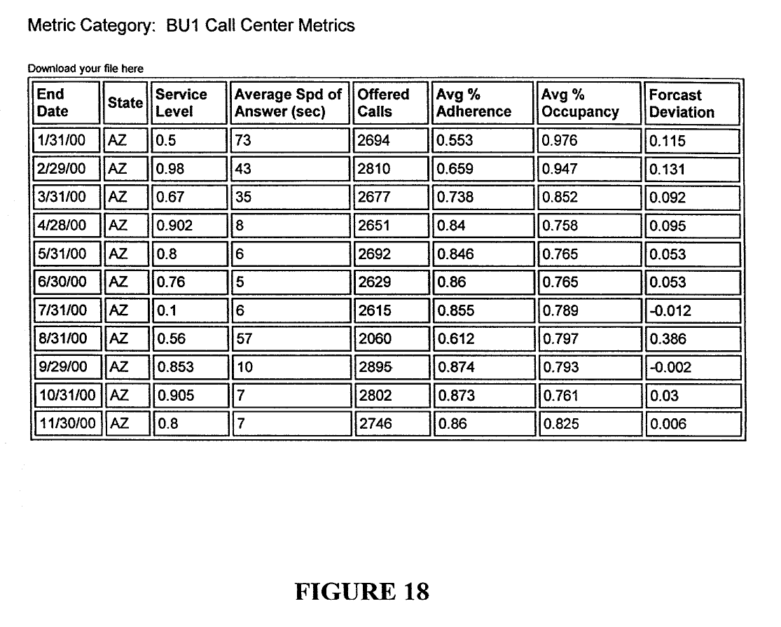

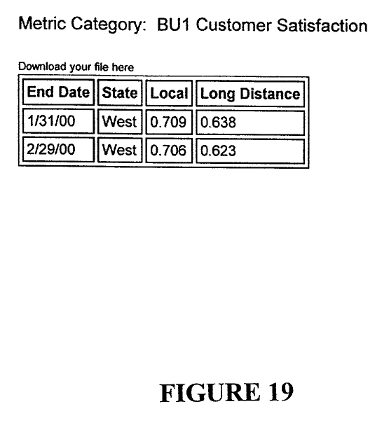

Calculate mean, range, standard deviation, variance and other descriptive statistics (FIGS. 18, 19 & 21)

2. The Planning Center

The Planning Center helps all members involved with a project to document and reference scope, timeline for completion, deliverables, schedule, staffing, and project issues.

An on-line, interactive Calendar provides an easy way for all team members to track day-to-day project activities. The Planet Workforce Calendar is unique because it provides features specifically designed to support transformation initiatives. Calendar functionality includes:

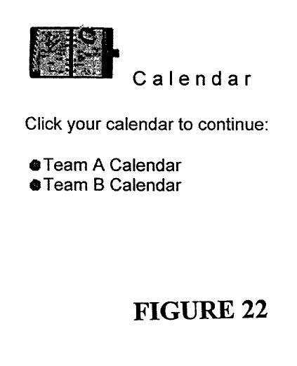

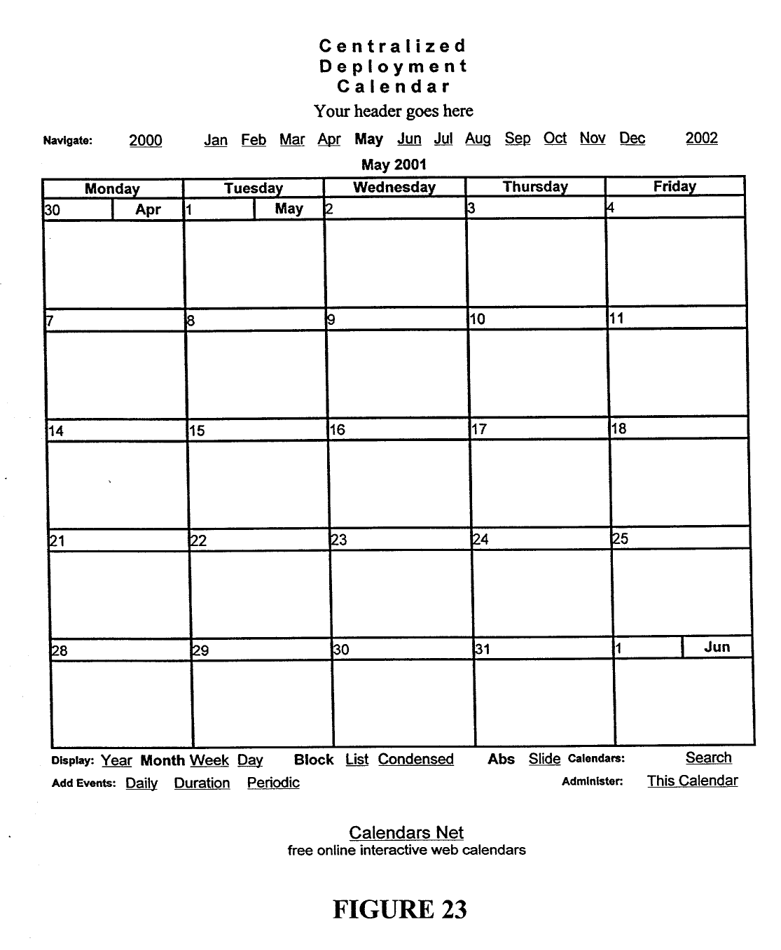

Multiple Calendar Views (FIGS. 22, 23)

Views for each project sub-team

Views that capture vacation and time off

Views that reflect workplan milestones

Password protected views

Custom views to match project needs

Daily, weekly, monthly, and yearly views

Meeting Scheduler

Select a conference room

Schedule meeting dial-in number

Create instant meeting agenda

Send alerts via e-mail and pager to meeting attendees

Post meeting information to shared calendar

Downloadable Information

Calendar events can be exported to Palm™ and other hand-held devices

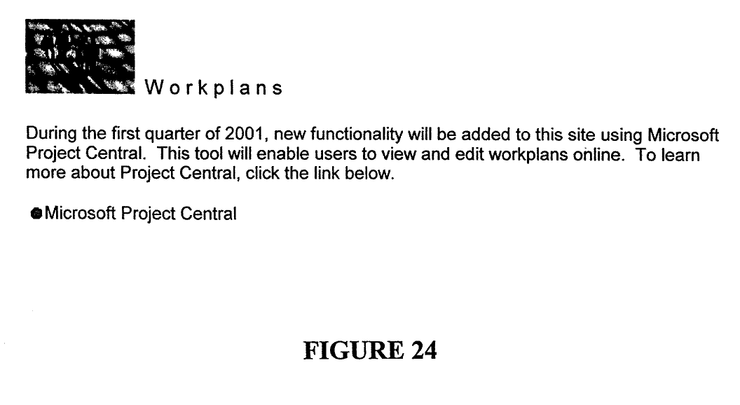

In this preferred embodiment Workforce Workplans can be either dynamic or static, depending on project needs. For projects enabled with Microsoft Project Central 2000, the preferred embodiment will provide a seamless link to on-line, collaborative planning and scheduling. (FIG. 24).

Alternatively, projects may choose to view static versions of their workplans. This option adds flexibility and accessibility since it requires no pre-existing software to be installed on the end-user's PC.

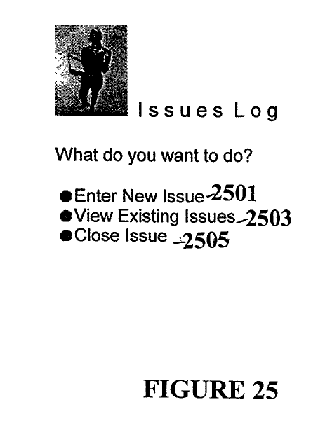

The preferred embodiment Issues Log enables users to log, view, change, close, and monitor project issues. (FIG. 25) The Issues Log is unique because it provides features specifically designed to support transformation initiatives. This exemplary system allows users to:

Log Issues

Information is automatically stored about the person who logged an issue and the date logged.

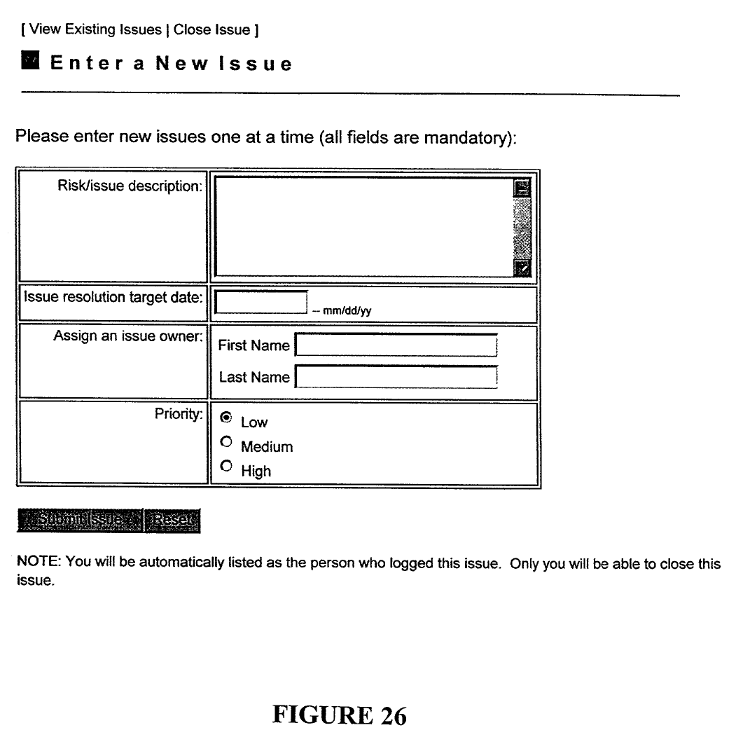

When logging a new issue, users provide issue description, issue owner, target date of resolution, subteam, and priority (high, medium, low). (FIG. 26).

Issue owners and other project members can be automatically notified when a new issue is logged.

View Issues

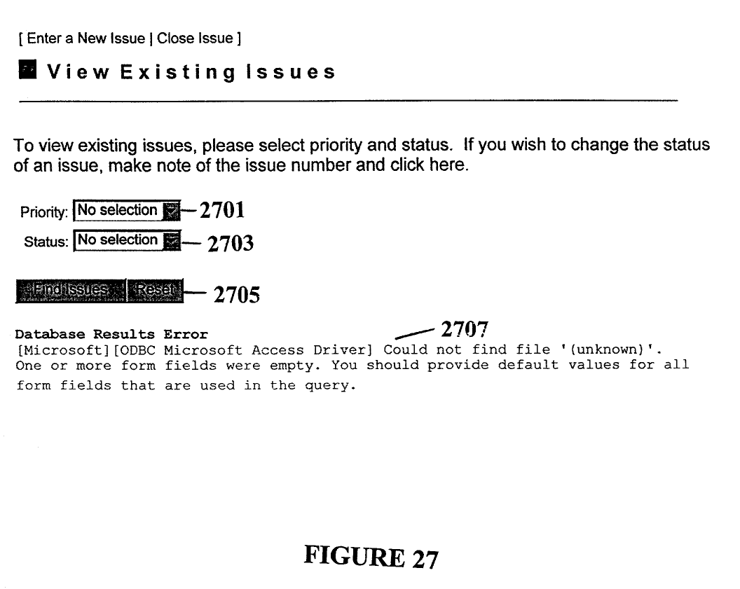

Users may view issues by status (closed, open, all) and priority (high, medium, low, all). (FIG. 27).

Change or Close Issues

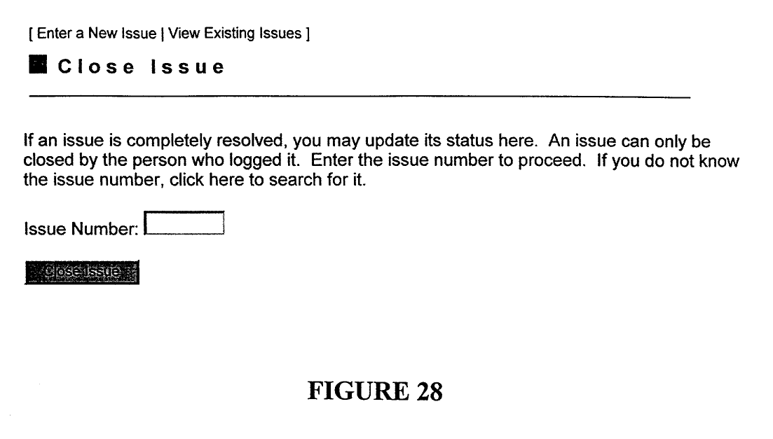

An issue can only be modified or closed by the user who logged it or the issue owner. (FIG. 28)

Issue loggers and owners may change the status or priority of an issue, or change the issue owner. Issue descriptions can be amended to include new or changed information. All changes are logged so that users can see when and what parameters of an issue have changed over time.

Issue owners and other project members can be automatically notified when an issue is changed or closed.

Monitor Issues

Users can generate dynamic issues reports by selecting criteria (e.g., date range, subteam) and filters (e.g., status, priority, days unresolved).

Reports can be viewed online, printed, sent via e-mail to specified project members, or exported to text files.

3. The Contribution Center

The Contribution Center (pointer is shown at 815 in FIG. 8) provides a forum for project members to submit accomplishments, feedback, ideas, and suggestions. Its purpose is to encourage users to take ownership of the project and strive for continuous improvement.

An on-line, interactive Accomplishments tool provides an easy way for all team members to submit status reports. The tool links back to workplans for easy reference to project milestones, critical dependencies, and target dates. In the exemplary system, users can:

Submit Accomplishments

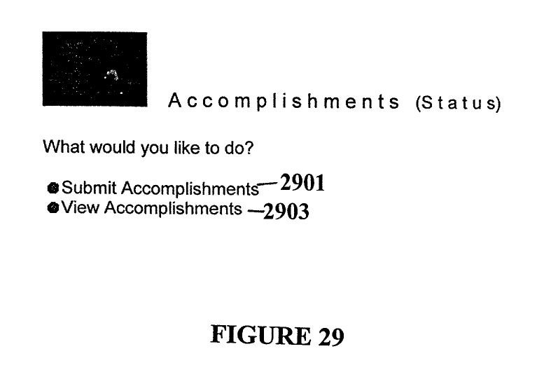

Information is automatically stored about the person who submitted an accomplishment and the date logged. (FIG. 29).

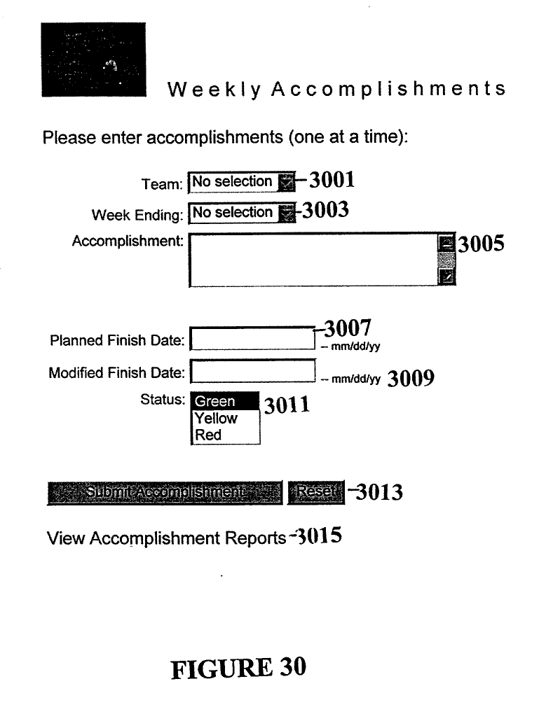

When logging an accomplishment, users provide a description, target date of completion, modified date of completion, estimated hours, actual hours, and subteam. (FIG. 30).

View Accomplishments

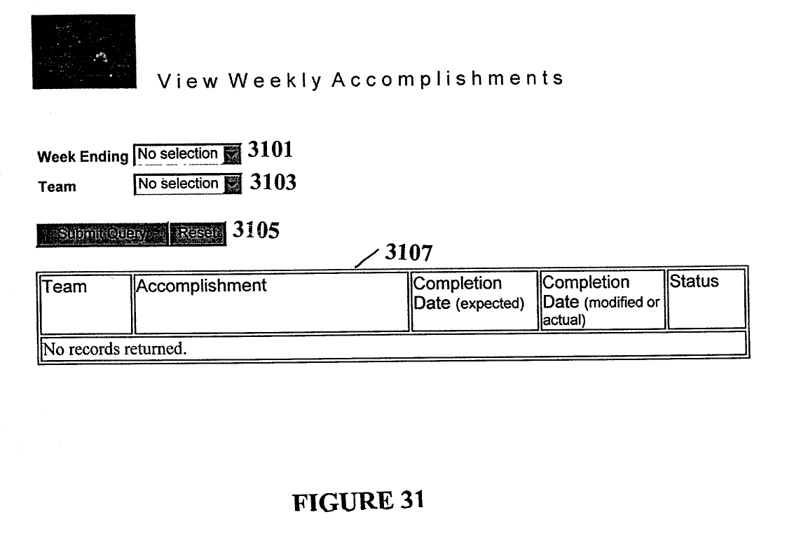

Users may view accomplishments by subteam and date. (FIG. 31)

Modify Accomplishments

The user who submitted it can modify an accomplishment. Monitor Accomplishments

Users can generate dynamic status reports by selecting subteams, individuals, and dates.

Reports can be viewed online, printed, sent via e-mail to specified project members, or exported to text files. (see icon 709 on the Home Page—FIG. 7).

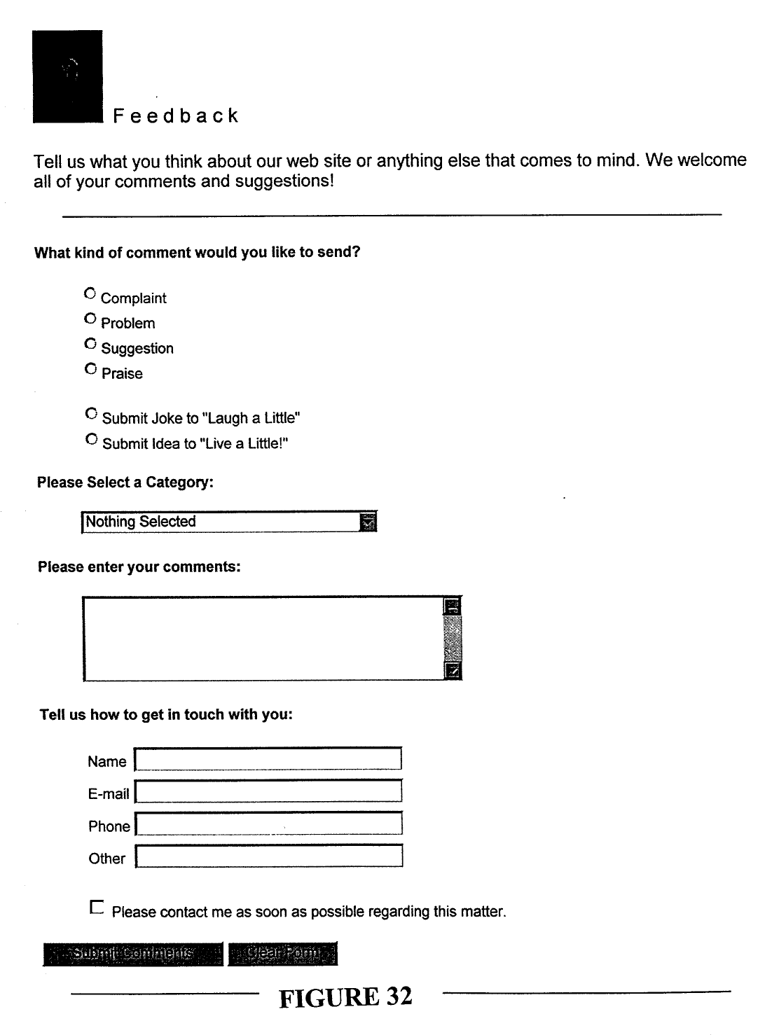

Users are encouraged to provide Feedback. An on-line Feedback form enables users to report technical problems with the site, suggest new functionality, request information, submit ideas, or comment on any aspect of the project. (FIG. 32)

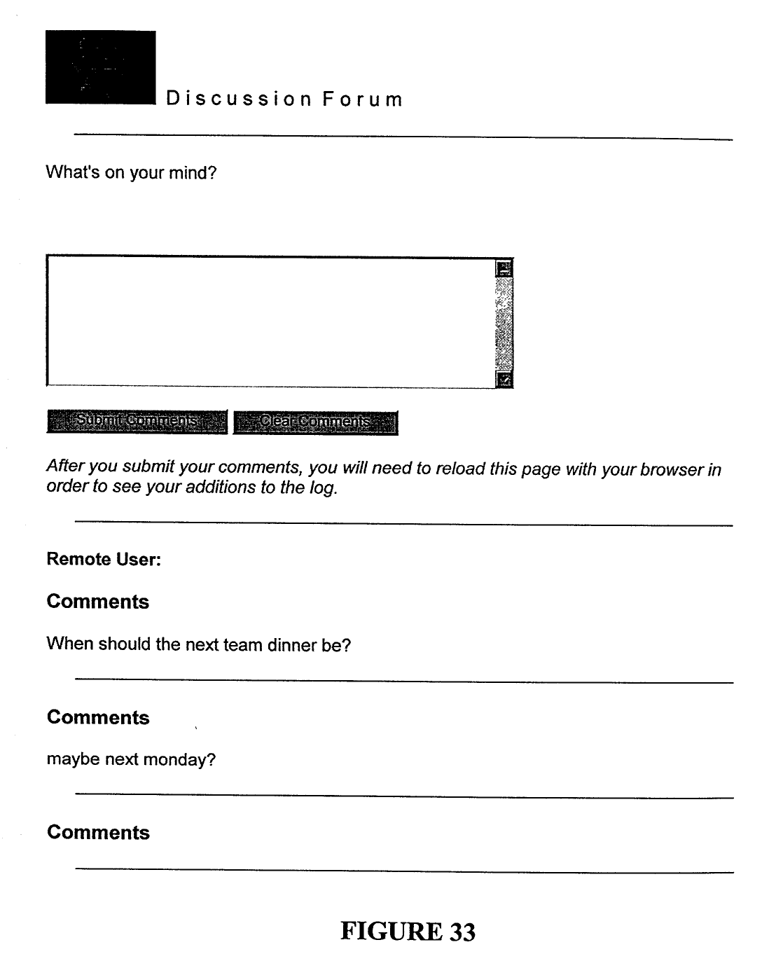

The Discussion Forum allows users to select topics, then view and post comments. Users can also open an on-line chat room (private or open to all project members). (FIG. 33).

4. The Information Center

The Information Center provides easy access to documents, best practices, reference codes (e.g., charge numbers), and other project information.

An on-line File Manager allows users to upload and download documents (e.g., Word, Excel, PowerPoint, etc.). The benefits are numerous. Users no longer need to send group e-mails with file attachments; document version control issues are mitigated (since the latest version of a document is always available); information is readily accessible from almost anywhere via the Internet; users may be asked to view on-line presentations prior to attending a meeting or other event.

5. Balanced Lifestyle

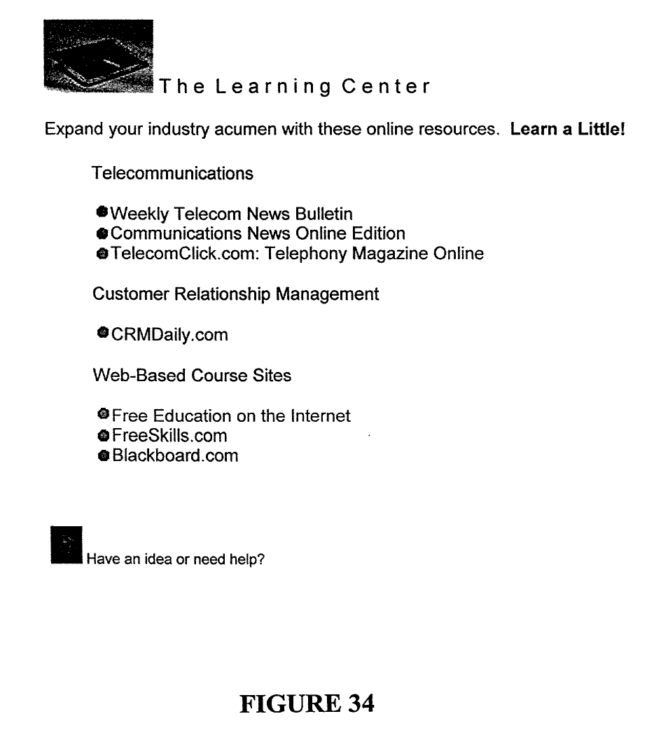

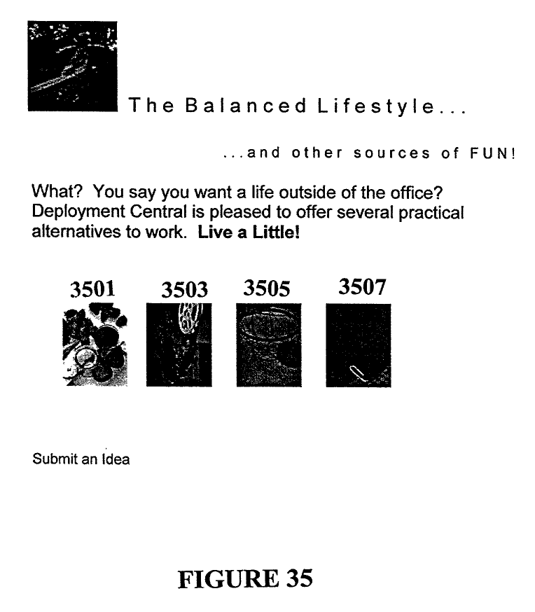

If users want to find out about local events taking place in their community (e.g., theater, wine tasting, fairs, festivals), they can click on the Live a Little link (717 on the Home Page—FIG. 7) to view current information. (FIG. 35 shows other data links). A new joke or cartoon is accessible each day by clicking on the Laugh a Little link (719 on the Home Page—FIG. 7). And finally, Learn a Little (715 on the Home Page FIG. 7) helps users acquire industry acumen by providing links to on-line journals and publications, find on-line courses matching interests or educational needs, or find information pertaining to project informational sessions (e.g., “brown-bags”). (FIG. 34).

Those skilled in these arts will recognize that additional desired links may be added to the Home Page (FIG. 7) or to the related data service tools as a particular project or management team may desire or find relevant.

User Information and Security

In the preferred embodiment, new users are provided with a temporary ID and password that expires within a certain number of hours or days. Before accessing the site, users complete a Registration form, during which they are asked to supply contact information, team affiliation, and other (customizable) information. Users select a unique logon ID and password (which must include both alpha and numeric characters and be 8 digits or longer).

Depending on a user's Permissions level (which must be assigned by the site administrator), some site features may not be accessible. This feature is fully customizable depending on a project's needs.

At any point during a project if a user needs to Change Contact Information, Planet Workforce provides an interface that makes it easy to do so. Common examples include changes in sub-team affiliation, changes in telephone/pager numbers, etc.

To search for a project member, users may access the express411™ tool. This tool provides special features such as the ability to search for a point of contact by sub-team affiliation or role (if name is not known. Users may also export contact information to Palm™ and other handheld devices.

When a user logs into the exemplary system, a unique session variable is stored that enables certain information to be captured for Security purposes. For example, certain entries (e.g., issues) may only be modified by a specific user or users. In addition, if a user tries to access a web page without first logging in, the absence of a session variable will make this action impossible. Other standard security features include HTTPS protocol and encrypted data. Additional security features that can bee added or customized depending on project needs include the use of Internet tunneling, Virtual Private Network, publication of site to a corporate web (or Intranet), etc.

Technical Requirements

The technical requirements for accessing the preferred embodiment are minimal and include:

Internet access (28.8 KPBS per second or faster)

Netscape™ or Microsoft Internet Explorer™ browser (3.0 or higher)

User Quick-Start

Prior to implementing the preferred embodiment of this exemplary system, a User Quick Start process enables a smooth application. This includes a series of three two-hour planning sessions with project leaders and/or a program management team, followed by a data collection effort and web site pilot.

First Planning Session: During this session, meeting participants begin to develop (or refine) a Business Case for their project. Following a review of industry targets, metrics are selected pertaining to financial, operational, and customer goals (these metrics eventually will be integrated into the project scorecard).

Second Planning Session: Participants finalize Business Case and begin to identify processes for gathering historical and ongoing data.

Third Planning Session: Requirements for the web site are refined and customized as needed.

Data Collection Effort: Processes are firmly established (manual and/or automated) for gathering project data on a regular basis.

Pilot: A small group of end-users is asked to participate in a weeklong pilot to ensure that requirements were met.

Those skilled in these arts will recognize that alternative embodiments may be developed to include such components as:

Performance Metrics Tools Component,

Best People tool set,

eLearning tool set,

eJourney management tool set,

and other similar management enhancing tools.

Having described the invention in terms of a preferred embodiment, it will be recognized by those skilled in the art that various types of general purpose computer hardware may be substituted for the configuration described above to achieve an equivalent result. Similarly, it will be appreciated that arithmetic logic circuits are configured to perform each required means in the claims for performing the various features of the rules engine and flow management. It will be apparent to those skilled in the art that modifications and variations of the preferred embodiment are possible, such as different computer systems may be used, different communications media such as wireless communications, as well as different types of software may be used to perform equivalent functions, all of which fall within the true spirit and scope of the invention as measured by the following claims.

I claim:

1. A data processing apparatus configured to provide data analysis to assist a business entity in improving operations relative to specified business metrics, the apparatus comprising:
at least one database system containing operations data related to the business entity;
a first computer mechanism, electronically coupled to the at least one database system, the first computer mechanism containing a set of performance metric tools, for use in measuring specified business operations;
a second computer mechanism, electronically coupled to the at least one database system, containing a set of management tools configured to produce data to assist the business entity in self measurement, metric comparisons, and strategic plans development through the use of data contained in the at least one database system; and
the performance metric tools and the management tools are configured to be accessible by a web-based client computer whereby information pertaining to a specific business entity management project may be accessed from the web-based client computer.

2. The apparatus of claim 1 further comprising a third computer mechanism electronically coupled to the at least one database system, the third computer mechanism configured to contain a set of tools for workforce planning and analysis, with a companion set of learning tools to provide strategic employee development assistance recommendations, whereby the business entity is provided recommendations for optimizing its operations with respect to the specific business metrics.

3. The apparatus of claim 1 wherein the at least one database system contains data related to one or more data centers which contain respectively data pertaining to knowledge operations, planning operations, contribution functions, information functions, and lifestyle functions.

4. The apparatus of claim 3 wherein the data center pertaining to knowledge operations comprises one or more data functions for viewing, manipulating, graphing or downloading data pertaining to one or more of Program Management/Financial data, Capability Development Status data, Capability Deployment Status data, Business Benefits status data, or Project Open Issues data.

5. The apparatus of claim 4 wherein the Program Management/Financial data comprises work complete data budget and actual, and project dollars data, budget and actual.

6. A data processing apparatus configured to provide data analysis to assist a business entity in improving operations relative to specified business metrics, the apparatus comprising:
at least one database system containing operations data related to the business entity;
a first computer mechanism, electronically coupled to the at least one database system, the first computer mechanism containing a set of performance metric tools, for use in measuring specified business operations;
a second computer mechanism, electronically coupled to the at least one database system, containing a set of management tools configured to produce data to assist the business entity in self measurement, metric comparisons, and strategic plans;
the performance metric tools and the management tools are configured to be accessible by a web-based client computer whereby information pertaining to a specific business entity management project may be accessed from the web-based client computer; and
a third computer mechanism electronically coupled to the at least one database system, the third computer mechanism configured to contain a set of tools for workforce planning and analysis, with a companion set of learning tools to provide strategic employee development assistance recommendations, whereby the business entity is provided recommendations for optimizing its operations with respect to the specific business metrics.

7. A data processing apparatus configured to provide data analysis to assist a business entity in improving operations relative to specified business metrics, the apparatus comprising:
at least one database system containing operations data related to the business entity;
a first computer mechanism, electronically coupled to the at least one database system, the first computer mechanism containing a set of performance metric tools, for use in measuring specified business operations; a second computer mechanism, electronically coupled to the at least one database system, containing a set of management tools configured to produce data to assist the business entity in self measurement, metric comparisons, and strategic plans; the performance metric tools and the management tools are configured to be accessible by a webbased client computer whereby information pertaining to a specific business entity management project may be accessed from the web-based client computer; and wherein the at least one database system contains data related to one or more data centers which contain respectively data pertaining to knowledge operations, planning operations, contribution functions, information functions, and lifestyle functions.

8. A computer implemented method to provide data analysis to assist a business entity in improving operations relative to specified business metrics, the method comprising the acts of.
providing at least one database system containing operations data related to the business entity;
providing a set of performance metric tools, for use in measuring specified business operations;
providing a set of management tools configured to produce data to assist the business entity in self measurement, metric comparisons, and strategic plans
development through the use of data contained in the at least one database system; and
providing a computer network interface from which the performance metric tools and the management tools can be accessed by a web-based client computer whereby information pertaining to a specific business entity management project may be accessed from the web-based client computer.

9. The computer implemented method of claim 8 further comprising an act of providing a set of tools for workforce planning and analysis, with a companion set of learning tools to provide strategic employee development assistance recommendations, whereby the business entity is provided recommendations for optimizing its operations with respect to the specific business metrics.

10. The computer implemented method of claim 8 wherein the at least one database system contains data related to one or more data centers which contain respectively data pertaining to knowledge operations, planning operations, contribution functions, information functions, and lifestyle functions.

11. The computer implemented method of claim 10 wherein a data center pertaining to knowledge operations comprises one or more data functions for viewing, manipulating, graphing or downloading data pertaining to one or more of Program Management/Financial data, Capability Development Status data, Capability Deployment Status data, Business Benefits status data, or Project Open Issues data.

12. The computer implemented method of claim 11 wherein the Program Management/Financial data comprises work complete data, budget and actual, and project dollars data, budget and actual.

13. A computer implemented method to provide data analysis to assist a business entity in improving operations relative to specified business metrics, the method comprising the acts of:
providing at least one database system containing operations data related to the business entity;
electronically coupling to the at least one database system, a set of performance metric tools, for use in measuring specified business operations;
electronically coupling to the at least one database system, a set of management tools configured to produce data to assist the business entity in self measurement, metric comparisons, and strategic plans;
configuring the performance metric tools and the management tools to be accessible by a web-based client computer whereby information pertaining to a specific business entity management project may be accessed from the web-based client computer; and
electronically coupling to the at least one database system, a set of tools for workforce planning and analysis, with a set of learning tools to provide strategic employee development assistance recommendations, whereby the business entity can be provided recommendations for optimizing its operations with respect to the specific business metrics.

14. A computer implemented method to provide data analysis to assist a business entity in improving operations relative to specified business metrics, the method comprising the acts of:
providing at least one database system containing operations data related to the business entity;
providing a first server mechanism electronically coupled to the at least one database system, the first server mechanism containing a set of performance metric tools, for use in measuring specified business operations;
providing a second server mechanism, electronically coupled to the at least one database system, containing a set of management tools configured to produce data to assist the business entity in self measurement, metric comparisons, and strategic plans;
wherein the performance metric tools and the management tools are configured to be accessible by a web-based client computer whereby information pertaining to a specific business entity management project may be accessed from the web-based client computer; and
wherein the at least one database system contains data related to one or more data centers which contain respectively data pertaining to at least one of knowledge operations, planning operations, contribution functions, information functions, and lifestyle functions.
